(19) United States
(12) Patent Application Publication
(10) Pub. No.: US 2026/0249655 A1
(43) Pub. Date: Aug. 27, 2026

(54) TIRE AND TIRE MOLD

(71) Applicants: The Yokohama Rubber Co., LTD., Kanagawa (JP); YOKOHAMA MOLD CO., LTD., Ibaraki (JP)

(72) Inventors: Noboru TAKADA, Ibaraki (JP); Hiroshi FURUSAWA, Kanagawa (JP)

(21) Appl. No.: 19/135,266

(22) PCT Filed: Nov. 2, 2023
(86) PCT No.: PCT/JP2023/039636

§ 371 Date: Jun. 3, 2025

(30) Foreign Application Priority Data
Dec. 8, 2022 (JP) 2022-196217

(51) Int. Cl. B60C 13/00; B29D 30/06; B29D 30/72

(52) U.S. Cl. CPC B60C 13/001; B29D 30/0606; B29D 30/72; B29D 2030/0612; B29D 2030/726

(57) ABSTRACT

A tire includes: in a sidewall portion, a marking portion and a background portion surrounding the marking portion; and a serration formed in any one of the marking portion and the background portion, the serration including a plurality of ridges arranged side by side. In the tire, each ridge has, in a cross section orthogonal to a length direction of the ridge, a sidewall surface having a negative gradient with respect to a normal line of a reference plane on which the ridge is formed and an inclined surface inclined with respect to the reference plane.

### TECHNICAL FIELD

The present technology relates to a tire including a serration formed in a sidewall portion and a tire mold for molding the tire and relates particularly to a tire and a tire mold that can provide an enhanced visual effect of light and dark based on the serration and exhibit excellent visibility.

### BACKGROUND ART

A proposed tire in which a marking portion composed of an alphanumeric, a pattern, a symbol, or the like and a background portion surrounding the marking portion are formed in a sidewall portion of the tire and a serration including a plurality of ridges arranged side by side is formed in any one of the marking portion and the background portion (see, for example, Japan Unexamined Patent Publication Nos. 2003-175707 A, 2019-147495 A, and 2020-6863 A). Providing such a serration in the sidewall portion can enhance the visibility of the marking portion by the visual effect of light and dark based on the serration.

However, although a high ridge is desirably formed to enhance the visual effect of light and dark, the height of the ridge is limited in the sidewall portion of the tire. Thus, there is a limit to the effect of improving visibility based on the height of the ridge.

### SUMMARY

The present technology is to provide a tire and a tire mold that can provide an enhanced visual effect of light and dark based on a serration and exhibit excellent visibility.

A tire according to an embodiment of the present technology includes: in a sidewall portion, a marking portion and a background portion surrounding the marking portion; and a serration formed in any one of the marking portion and the background portion, the serration including a plurality of ridges arranged side by side.

In the tire, each ridge of the ridges has, in a cross section orthogonal to a length direction of the ridge, a sidewall surface having a negative gradient with respect to a normal line of a reference plane on which the ridge is formed and an inclined surface inclined with respect to the reference plane.

A tire mold according to an embodiment of the present technology is a tire mold for molding the above-described tire and includes a molding surface having a shape corresponding to the marking portion, the background portion, and the serration.

In the present technology, each ridge has the sidewall surface having a negative gradient with respect to the normal line of the reference plane. This easily forms a shadow along the ridges and effectively absorbs light between the ridges. Each ridge has the inclined surface inclined with respect to the reference plane, and thus the inclined surface effectively reflects light. Therefore, the structure of the ridge can enhance the visual effect of light and dark based on the serration while allowing the height of the ridge to be kept low and exhibit excellent visibility.

In the present technology, each ridge preferably forms a polygon in a cross section orthogonal to the length direction of the ridge. When the cross-sectional shape of the ridge is polygonal in this manner, the reflection direction of light changes according to the cross-sectional shape. This can have variations of the visual effect of brightness and darkness. In particular, when the cross-sectional shape of the ridge is triangular, the visual effect of light and dark can be enhanced.

An angle α of the sidewall surface with respect to the normal line of the reference plane is preferably in a range −20°≤α<0°. Setting the angle α of the sidewall surface in the above-described range can enhance the visual effect of light and dark.

An apex angle β of the ridge in a cross section orthogonal to the length direction of the ridge is preferably in a range 30°≤β≤60°. Setting the apex angle of the ridge in the above range can enhance the visual effect of light and dark.

A pitch of the ridge preferably ranges from 0.5 mm to 1.2 mm, and a height of the ridge preferably ranges from 0.2 mm to 0.5 mm. The ridge having the above-described cross-sectional shape is excellent in visibility. Therefore, the pitch of the ridge can be increased, and the height of the ridge can be reduced. This can reduce the number of ridges and improve the processing workability of the tire mold.

The ridge preferably includes a chamfered portion composed of a flat surface or a curved surface between the sidewall surface and the inclined surface. When such a chamfered portion is provided, the direction of absorption or reflection of light changes. This can have variations of the visual effect of light and dark.

The tire according to an embodiment of the present technology may be a pneumatic tire, or may be a non-pneumatic tire. In a case of a pneumatic tire, the interior thereof can be filled with any gas including air and inert gas such as nitrogen. Non-pneumatic tires include solid tires.

### BRIEF DESCRIPTION OF DRAWINGS

FIG. 1 is a meridian cross-sectional view illustrating a pneumatic tire according to an embodiment of the present technology.

FIG. 2 is a plan view illustrating a marking portion and a background portion formed in a sidewall portion, and a serration formed in the marking portion.

FIG. 3 is a cross-sectional view taken along the line III-III of FIG. 2.

FIG. 4 is a cross-sectional view of FIG. 3 with dimension lines added.

FIG. 5 is a plan view illustrating the marking portion and the background portion formed in the sidewall portion, and the serration formed in the background portion.

FIG. 6 is a cross-sectional view illustrating an example of a reflection state of light in the sidewall portion.

FIG. 7 is a cross-sectional view illustrating a modified example of the serration.

FIG. 8 is a cross-sectional view illustrating another modified example of the serration.

FIG. 9 is a cross-sectional view illustrating another modified example of the serration.

FIG. 10 is a cross-sectional view illustrating one example of a tire mold of an embodiment of the present technology.

### DETAILED DESCRIPTION

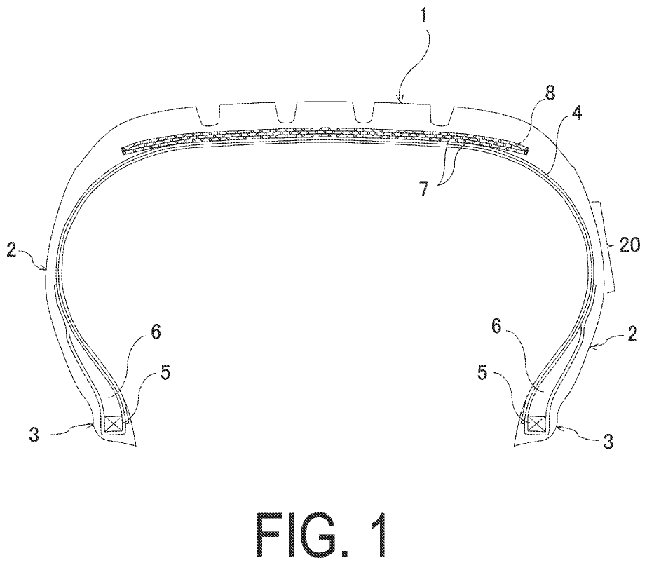

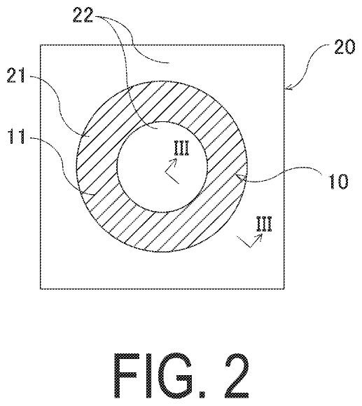

Configurations of embodiments of the present technology will be described in detail below with reference to the accompanying drawings. FIG. 1 illustrates a pneumatic tire according to an embodiment of the present technology, and FIGS. 2 to 4 illustrate the main portion of the pneumatic tire.

As illustrated in FIG. 1, a pneumatic tire of the present embodiment includes a tread portion 1 extending in a tire circumferential direction and having an annular shape, a pair of sidewall portions 2, 2 disposed on both sides of the tread portion 1, and a pair of bead portions 3, 3 disposed on inner sides of the sidewall portions 2, 2 in a tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and composed of a rubber composition is disposed on the outer circumference of the bead core 5.

On the other hand, a plurality of belt layers 7 is embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7 the inclination angle of the reinforcing cords with respect to the tire circumferential direction is set to fall in a range from 10° to 40° for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example of a pneumatic tire, but the pneumatic tire is not limited thereto. Various grooves such as a main groove extending in the tire circumferential direction and a lug groove extending in the tire width direction are formed in the tread portion 1.

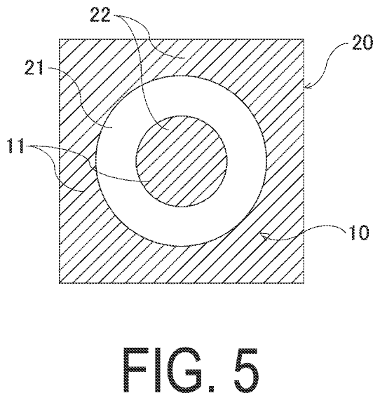

As illustrated in FIG. 2, a decorative portion 20 is formed in the sidewall portion 2. The decorative portion 20 includes a marking portion 21 and a background portion 22 surrounding the marking portion 21. The marking portion 21 forms an alphanumeric, a pattern, a symbol, or the like and is recessed from the background portion 22. Then, the marking portion 21 is formed with a serration 10 including a plurality of ridges 11 arranged side by side. The ridge 11 is a protrusion protruding from a reference plane B, and the serration 10 is an aggregate of the ridges 11. The background portion 22 may have a structure recessed from the marking portion 21, and the serration 10 including a plurality of ridges 11 arranged side by side may be formed on the background portion 22 (see FIG. 5).

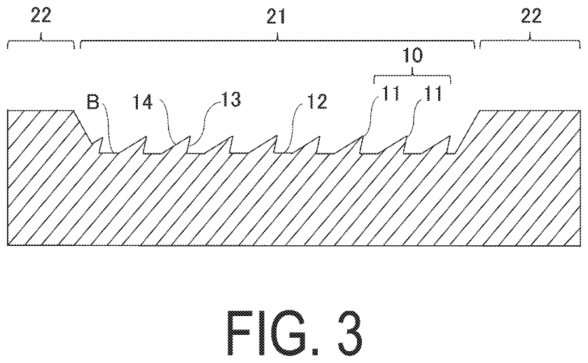

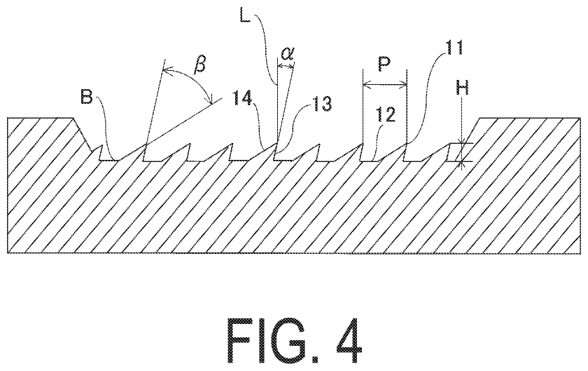

As illustrated in FIGS. 3 and 4, in a cross section orthogonal to the length direction of the ridge 11, each ridge 11 has a sidewall surface 13 having a negative gradient with respect to a normal line L of the reference plane B on which the ridge 11 is formed and an inclined surface 14 inclined with respect to the reference plane B. That is, each ridge 11 forms a triangle in a cross section orthogonal to the length direction of the ridge 11. The reference plane B is a plane passing through base ends of a plurality of the sidewall surfaces 13 and coincides with a bottom surface 12 between the adjacent ridges 11, 11 in FIGS. 3 and 4. The ridge 11 (having the sidewall surface 13) having a negative gradient with respect to the normal line L of the reference plane B means that a part of the ridge 11 has an undercut shape protruding above the bottom surface 12. A top surface of the background portion 22 is parallel to the reference plane B.

In the above-described tire, each ridge 11 has the sidewall surface 13 having a negative gradient with respect to the normal line L of the reference plane B. This easily forms a shadow along the ridges 11 and effectively absorbs light between the ridges 11, 11. Each ridge 11 has the inclined surface 14 inclined with respect to the reference plane B, and thus the inclined surface 14 effectively reflects light. Therefore, the structure of the ridge 11 can enhance the visual effect of light and dark based on the serration 10 while allowing the height of the ridge 11 to be kept low and exhibit excellent visibility.

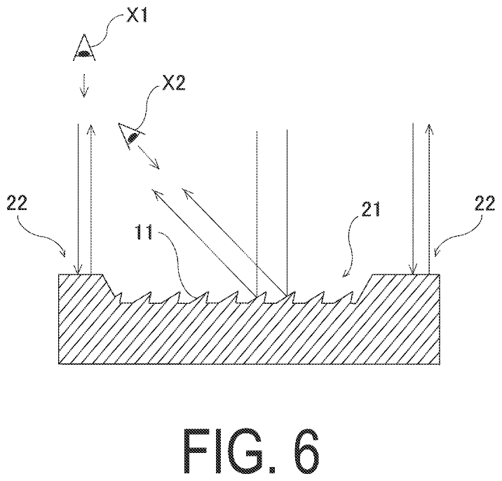

FIG. 6 illustrates an example of a reflection state of light in the sidewall portion. In FIG. 6, when it is assumed that light sources are located in front of the sidewall portion 2, the marking portion 21 appears black and the background portion 22 appears bright due to reflection of light in a viewing direction X1 in which the sidewall portion 2 is viewed from the front. In particular, since the ridge 11 has an undercut shape and the light entering between the ridges 11, 11 is hardly reflected, the blackening of the marking portion 21 is promoted. On the other hand, at a viewing position X2 in which the sidewall portion 2 is viewed obliquely from one direction side with respect to the front, the marking portion 21 appears bright due to reflection of light and the background portion 22 appears black.

In the tire described above, as illustrated in FIG. 4, each ridge 11 preferably forms a triangle in a cross section orthogonal to the length direction of the ridge 11. When the cross-sectional shape of the ridge 11 is triangular, the visual effect of light and dark can be enhanced.

In the tire described above, an angle α of the sidewall surface 13 with respect to the normal line L of the reference plane B is preferably in the range −20°≤α<0°. The angles α mean an undercut shape when being negative values and mean a non-undercut shape when being positive values. By setting the angle α of the sidewall surface 13 to a negative gradient in the above-described range, the visual effect of light and dark can be enhanced. Here, if the angle α of the sidewall surface 13 is greater than 0°, the effect of absorbing light decreases. In contrast, if the angle α is smaller than −20°, mold machining becomes difficult. In particular, the angle α of the sidewall surface 13 is preferably in the range −5°≤α<−15°.

In the tire described above, an apex angle β of the ridge 11 in a cross section orthogonal to the length direction of the ridge 11 is preferably in the range 30°≤β≤60°. The apex angle β is an angle formed by the sidewall surface 13 and the inclined surface 14 in a cross section orthogonal to the length direction of the ridge 11. Setting the apex angle β of the ridge 11 in the above range can appropriately disperse the reflection direction of light and enhance the visual effect of light and dark. If the apex angle β of the ridge 11 is out of the above range, the effect of appropriately dispersing the reflection direction of light is reduced.

In the tire described above, a pitch P of the ridge 11 preferably ranges from 0.5 mm to 1.2 nm, and a height H of the ridge 11 preferably ranges from 0.2 mm to 0.5 mm. The ridge 11 having the above-described cross-sectional shape is excellent in visibility. Therefore, the pitch P of the ridge 11 can be increased and the height H of the ridge It can be reduced. Therefore, it is also possible to reduce the number of ridges 11 and improve the processing workability of the tire mold. In particular, the pitch P of the ridge 11 preferably ranges from 0.55 mm to 0.8 mm, and the height H of the ridge 11 preferably ranges from 0.25 mm to 0.4 mm.

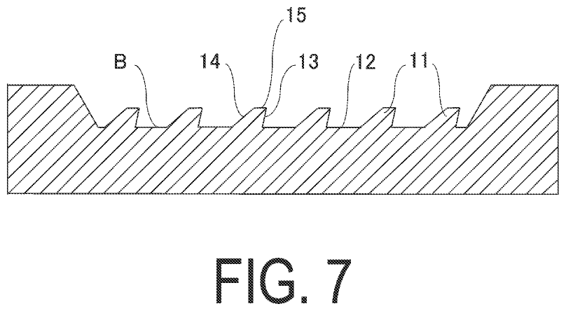

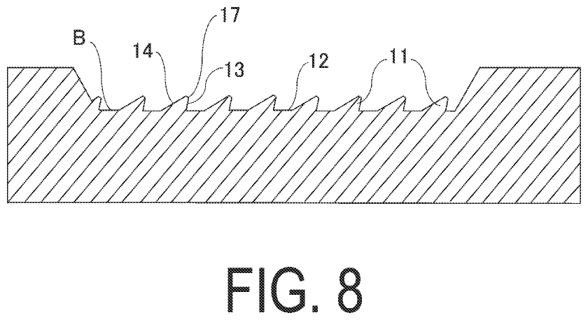

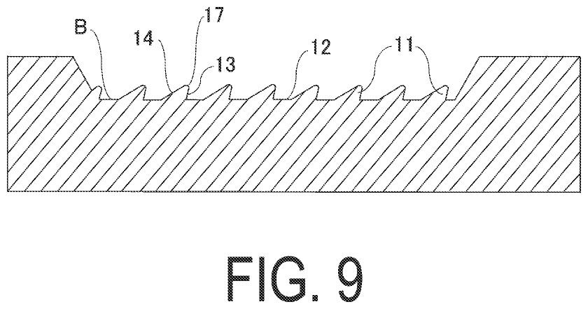

In the example of FIG. 3, each ridge 11 forms a triangle in a cross section orthogonal to the length direction of the ridge 11. On the other hand, in the example of FIG. 7, each ridge 11 forms a trapezoid in a cross section orthogonal to the length direction of the ridge 11. That is, in FIG. 7, in a cross section orthogonal to the length direction of the ridge 11, each ridge 11 has the sidewall surface 13 having a negative gradient with respect to the normal line L of the reference plane B on which the ridge 11 is formed, the inclined surface 14 inclined with respect to the reference plane B, and a top surface 15 connecting the sidewall surface 13 and the inclined surface 14. When the cross-sectional shape of the ridge 11 is polygonal, the reflection direction of light changes according to the cross-sectional shape This can have variations of the visual effect of light and dark. In the tire described above, as illustrated in FIGS. 8 and 9, the ridge 11 preferably includes a chamfered portion 17 composed of a flat surface or a curved surface between the sidewall surface 13 and the inclined surface 14. In the example of FIG. 8, the chamfered portion 17 composed of a flat surface is formed. In the example of FIG. 9, the chamfered portion 17 composed of a curved surface is formed. When such a chamfered portion 17 is provided, the direction of absorption or reflection of light changes. This can have variations of the visual effect of light and dark.

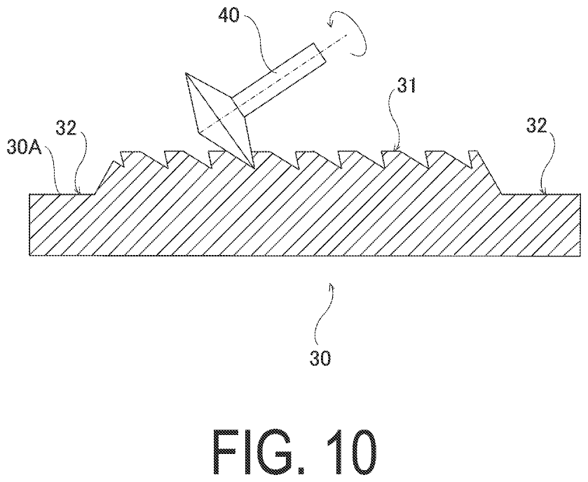

FIG. 10 illustrates one example of a tire mold of an embodiment of the present technology. In FIG. 10, only a main portion of a side plate 30 in which the sidewall portion 2 of the tire is molded is depicted. However, the configuration of the other portions is not particularly limited, and a known structure can be employed as a tire mold.

In the tire mold of an embodiment of the present technology, a molding surface 30A of the side plate 30 for forming the sidewall portion 2 of the tire includes a marking forming portion 31 corresponding to the marking portion 21 and a background forming portion 32 corresponding to the background portion 22, and the marking forming portion 31 is projected more than the background forming portion 32. Then, the marking forming portion 31 is processed into a shape corresponding to the serration 10. The tire according to an embodiment of the present technology can be molded by vulcanizing a tire in an unvulcanized state with the tire mold including the side plate 30 having the molding surface 30A having a shape corresponding to the marking portion 21, the background portion 22, and the serration 10 as described above.

A processing method of the above-described tire mold is not particularly limited. However, for example, the molding surface 30A having a desired shape can be processed by using a double angular cutter 40 as illustrated in FIG. 10 or a dovetail groove cutter (not illustrated).

### EXAMPLE

Tires of a Comparative Example and Examples 1 to 11 were manufactured. The tires have a marking portion and a background portion surrounding the marking portion in a sidewall portion and having a serration including a plurality of ridges arranged side by side formed in the marking portion. In the tires, the shape of the ridge was variously changed.

Each ridge of the Comparative Example has, in a cross section orthogonal to the length direction of the ridge, a sidewall surface having 0° with respect to a normal line to a reference plane on which the ridge is formed, and an inclined surface inclined with respect to the reference plane, and has a cross-sectional shape forming a triangle. Each ridge of the Examples 1 to 11 has, in a cross section orthogonal to the length direction of the ridge, a sidewall surface having a negative gradient width respect to the normal line to the reference plane on which the ridge is formed, and an inclined surface inclined with respect to the reference plane and has a cross-sectional shape forming a triangle. In the Comparative Example and Examples 1 to 11, the angle α of the sidewall surface of the ridge, the apex angle β of the ridge, the pitch P of the ridge, and the height H of the ridge were set as shown in Table 1.

The visibility of these test tires was evaluated by the following test methods, and the results are shown in Table 1.

### Visibility:

Twenty testers visually observed the sidewall portion of each test tire from various angles, confirmed the marking portion distinguished from the background portion due to absorption or reflection of light, and evaluated the visibility of the marking portion. The evaluation was carried out on a 5-point scale, with the Comparative example being given a score of 3 points. Evaluation results are expressed as index values based on the sum of the evaluation points of the twenty testers, with the Comparative Example being assigned an index value of 100. Larger index values indicate superior visibility.

TABLE 1-1

| | Comparative | Example | Example | Example |
|---|---|---|---|---|
| | Example | 1 | 2 | 3 |
| Cross-sectional shape of ridge | Triangle | Triangle | Triangle | Triangle |
| Angle α of sidewall surface of ridge (°) | 0 | −5 | −10 | −15 |
| Apex angle β of ridge (°) | 60 | 30 | 30 | 30 |
| Pitch of ridge P (mm) | 0.6 | 0.6 | 0.55 | 0.6 |
| Height of ridge H (mm) | 0.3 | 0.4 | 0.3 | 0.3 |
| Visibility (index value) | 100 | 125 | 130 | 125 |

TABLE 1-2

| | Example | Example | Example | Example |
|---|---|---|---|---|
| | 4 | 5 | 6 | 7 |
| Cross-sectional shape of ridge | Triangle | Triangle | Triangle | Triangle |
| Angle α of sidewall surface of ridge (°) | −20 | −5 | −10 | −15 |
| Apex angle β of ridge (°) | 30 | 45 | 45 | 45 |
| Pitch of ridge P (mm) | 0.6 | 0.55 | 0.55 | 0.7 |
| Height of ridge H (mm) | 0.3 | 0.3 | 0.3 | 0.3 |
| Visibility (index value) | 125 | 125 | 125 | 130 |

TABLE 1-3

| | Example | Example | Example | Example |
|---|---|---|---|---|
| | 8 | 9 | 10 | 11 |
| Cross-sectional shape of ridge | Triangle | Triangle | Triangle | Triangle |
| Angle α of sidewall surface of ridge (°) | −5 | −5 | −10 | −20 |
| Apex angle β of ridge (°) | 45 | 60 | 60 | 30 |
| Pitch of ridge P (mm) | 0.65 | 0.8 | 0.8 | 0.55 |
| Height of ridge H (mm) | 0.4 | 0.3 | 0.25 | 0.25 |
| Visibility (index value) | 120 | 110 | 110 | 120 |

As can be seen from Table 1, the tires of the Examples 1 to 11 had excellent visibility compared with that of the Comparative Example.

1. A tire, comprising: in a sidewall portion, a marking portion and a background portion surrounding the marking portion; and a serration formed in any one of the marking portion and the background portion, the serration including a plurality of ridges arranged side by side;
each ridge of the ridges having, in a cross section orthogonal to a length direction of the ridge, a sidewall surface having a negative gradient with respect to a normal line of a reference plane on which the ridge is formed and an inclined surface inclined with respect to the reference plane.

2. The tire according to claim 1, wherein each ridge forms a polygon in the cross section orthogonal to the length direction of the ridge.

3. The tire according to claim 1, wherein each ridge forms a triangle in the cross section orthogonal to the length direction of the ridge.

4. The tire according to claim 1, wherein an angle α of the sidewall surface with respect to the normal line of the reference plane is in a range −20°≤α<0°.

5. The tire according to claim 1, wherein an apex angle β of the ridge in the cross section orthogonal to the length direction of the ridge is in a range 30°≤β≤60°.

6. The tire according to claim 1, wherein a pitch of the ridge ranges from 0.5 mm to 1.2 mm, and a height of the ridge ranges from 0.2 mm to 0.5 mm.

7. The tire according to claim 1, wherein the ridge includes a chamfered portion composed of a flat surface or a curved surface between the sidewall surface and the inclined surface.

8. A tire mold for molding the tire according to claim 1, the tire mold comprising a molding surface having a shape corresponding to the marking portion, the background portion, and the serration.

9. The tire according to claim 3, wherein an angle α of the sidewall surface with respect to the normal line of the reference plane is in a range −20°≤α<0°.

10. The tire according to claim 9, wherein an apex angle β of the ridge in the cross section orthogonal to the length direction of the ridge is in a range 30°≤β≤60°.

11. The tire according to claim 10, wherein a pitch of the ridge ranges from 0.5 mm to 1.2 mm, and a height of the ridge ranges from 0.2 mm to 0.5 mm.

12. The tire according to claim 11, wherein the ridge includes a chamfered portion composed of a flat surface or a curved surface between the sidewall surface and the inclined surface.

13. A tire mold for molding the tire according to claim 12, the tire mold comprising a molding surface having a shape corresponding to the marking portion, the background portion, and the serration.
